(19) United States
(12) Patent Application Publication
(10) Pub. No.: US 2009/0162666 A1
(43) Pub. Date: Jun. 25, 2009

(54) CURABLE FLEXIBLE MATERIAL

(75) Inventor: Jurgen H. Daniel, San Francisco, CA (US)

Correspondence Address: MARGER JOHNSON & MCCOLLOM/PARC, 210 MORRISON STREET, SUITE 400, PORTLAND, OR, 97204, US

(73) Assignee: PALO ALTO RESEARCH CENTER INCORPORATED, Palo Alto, CA (US)

(21) Appl. No.: 11/961,762

(22) Filed: Dec. 20, 2007

(51) Int. Cl. B32B 17/06; B32B 38/00; B32B 15/04; B32B 9/04; B32B 27/06

(52) U.S. Cl. 428/426; 428/411.1; 428/447; 428/704; 428/500; 428/457; 428/688; 156/281

(57) ABSTRACT

A flexible structure has at least one elastomeric layer, at least two structural elements adjacent the elastomeric layer, and a curable material arranged adjacent to the elastomeric layer and the structural elements. A method of manufacturing a flexible structure includes adhering an elastomeric layer to at least two structural components to form a flexible structure, applying a curable material to the flexible structure such that the curable material is arranged adjacent to the elastomeric layer and the structural components. An apparatus has at least one elastomeric layer, at least two structural components arranged adjacent to and in contact with the elastomeric layer, a functional component arranged adjacent to and in contact with at least one of the structural components, and a curable material arranged adjacent to the elastomeric layer and the structural components.

### BACKGROUND

New ultra-stretchable polymer tapes have recently become available. These tapes have many uses, including artificial muscles. One such example is VHB™ from 3M™. This tape is generally thin and pliant, but strong. Other such tapes have also recently become available due to advances in polymer science.

These tapes have a wide range of applications, including window glazing and other construction applications, as well as in electronics. Generally, these tapes are applied to structures but do not have a very robust mechanical structure themselves.

### BRIEF DESCRIPTION OF THE DRAWINGS

FIG. 1 shows an embodiment of a flexible material curable into rigid form.

FIG. 2 shows a top view of alternative architectures of structural elements.

FIG. 3 shows an alternative embodiment of a flexible material curable into rigid form.

FIG. 4 shows an alternative embodiment of a flexible material curable into rigid form.

FIG. 5 shows a flowchart of one embodiment to manufacture a flexible material curable into rigid form.

FIG. 6 shows an embodiment of a process to form a flexible material into rigid form.

FIG. 7 shows an embodiment of a flexible material having structural components with flexure beams.

FIG. 8 shows an embodiment of a flexible material internally curable into rigid form.

FIG. 9 shows an embodiment of a flexible material internally curable into rigid form formed into a hinge.

FIG. 10 shows an embodiment of a flexible material internally curable into rigid form having a deforming actuator.

### DETAILED DESCRIPTION OF THE EMBODIMENTS

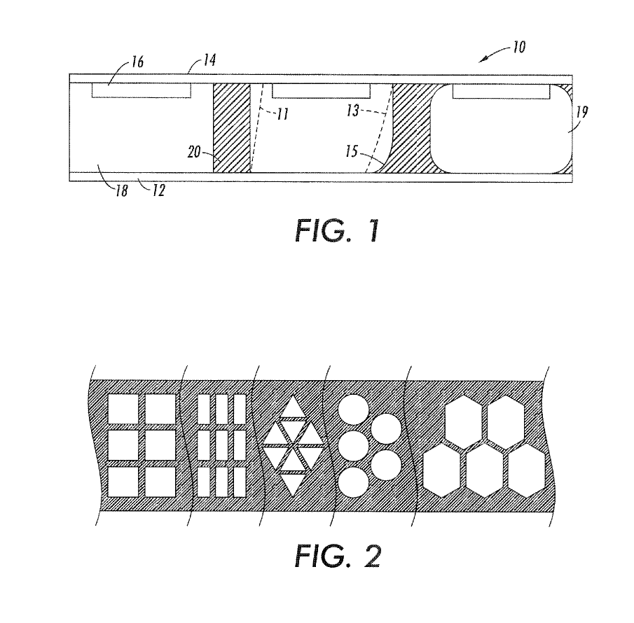

FIG. 1 shows an example of a structure. While this structure is manufactured, it may also be referred to here as a ‘material’ because it also has properties of materials, such as being usable as a component of a structure. The material or structure is flexible initially, but curable into rigid form.

In the embodiment of FIG. 1, the material 10 has first and second elastomeric layers 12 and 14. The elastomeric layers in this embodiment could be one of several different substances, including VHB™ tape from 3M™, silicones, acrylics, polyurethanes, nitrile, neoprene and rubber or rubber-based materials, referred to here collectively as rubber. By definition an elastomer is a material that has significant elastic qualities. Elastomers typically have a low modulus of elasticity, they are extremely flexible and can reversibly extend from ˜5-700%, depending on the specific material. From a chemical point of view, elastomers are cross-linked, amorphous polymers above their glass transition temperature. Various classes of elastomers are described for example in “Introduction to physical polymer science”, by L. H. Sperling (Wiley, 3^{rd} edition, 2001). As will be discussed in more detail later, the elastomeric layers may be replaced by a single elastomeric layer.

The elastomeric layers 12 and 14 enclose at least partially structural elements such as 18. The structural elements may be made from acrylic, such as polymethyl methacrylate (PMMA), other plastics, metals such as stainless steel, glass, ceramic, silicon, gallium arsenide, sapphire or plexiglass or other rigid or semi-rigid materials. The materials may have special properties such as high hardness, heat reflecting properties, strong heat absorbing properties or light reflecting or absorbing properties. The structural elements may be cut into various shapes by laser cutting, etching, dicing, stamping or they may be molded or otherwise grown such as via electroplating. Alternatively, the structures may be electrochemically grown by electroplating, and then remove the ‘free’ areas using photoresist to protect them.

An array of squares such as 18 separated by the area 20 may form the material, but the structural element 18 may be many other shapes, such as round, hexagonal, rectangular, etc. Spherical or elliptical structures also may be possible and they may be made by methods such as emulsion aggregation, jet-printing or grinding. This is shown by the element 19 to the far right of FIG. 1. The shape of the structural elements may vary from either the side or the top view.

For example, the shapes as seen from the top view of the structural elements include squares, rectangles, triangles, circular or hexagonal shapes. This is shown by FIG. 2. In FIG. 2, the top layer 14 of FIG. 1 has been removed so the shape of the structures can be seen. The curable material fills the gaps between structural elements that can be of many different shapes. Examples of a square, a rectangle, a triangle, a circle or a hexagon are merely examples and are not intended to limit the scope of the invention, nor should such limitation be implied.

The side-walls of the structural elements may be perpendicular to the top surface or they may be sloped so that a structural element has a trapezoidal shape when viewed from the side. The walls could slope inward as shown at 11, making the structural elements narrower at the top than at the bottom. Similarly, the structural elements could have walls sloping outwards, making the structural elements narrower at the bottom than the top. Further, the walls could be rounded, such as that shown by 15. These shapes may allow enhanced bending of the material in one bending direction. The structural elements in this embodiment may bond to the elastomeric layers using an adhesive, such as a pressure-sensitive adhesive tape, hot lamination, heat-sensitive adhesives, epoxies, etc. The structural layer may also bond to the elastomeric layer through the intrinsic bonding forces of the elastomer layer.

The structural elements such as 18 may also have bonded or otherwise attached to them functional elements such as 16. The functional elements may be patterned onto the structural elements before or after the structural elements are divided into individual elements. The functional elements could take many forms, including sensors, microelectromechanical systems (MEMS) elements, bolometers for infrared sensing, photovoltaic (solar) cells, light emitting devices such as light emitting diodes or other visual display elements, electronic circuits, structures with optical functionality, etc. The functional elements could be electrically or optically active elements or they could be simple passive structures. Passive functional elements would include optical corner cube reflectors, passive antenna structures to absorb or reflect electromagnetic radiation, passive magnetic elements such as permanent magnets, etc.

Arranged in between the structural elements are pockets or other regions of a curable polymer, liquid or other easily deformable material. The curable material may be heat-curable, radiation-curable, including light or UV-light curable, or curable by exposure to oxygen or moisture, among other types of curing. Upon curing, the material transforms from a liquid, viscous, visco-elastic or elastomeric form into a significantly more rigid or hardened form. The thickness or width of the regions of curable material between the structural elements may be varied to achieve the desired pliability and the desired rigidity when cured.

Similarly, the size of the structural elements, the thickness of the elastomeric layers, as well as the spacing between the structural elements may also be varied. The manufacturer of the material will have several variables to allow control of the initial and final properties of the material.

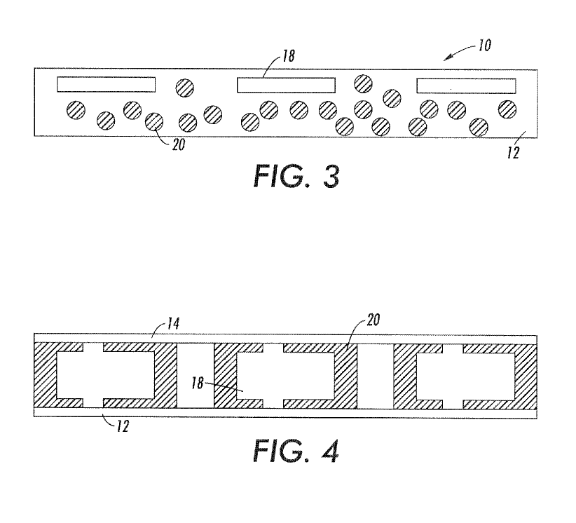

Further, the structure of the material may take the form of a highly elastic elastomeric layer 12 with pockets or other self-contained regions of curable substance 20 such as those shown in FIG. 3. Substance 20 may be a liquid or viscous, highly deformable material, that hardens upon curing. These pockets will be referred to as being ‘embedded’ in the elastomeric layer, regardless of how the pockets are actually created. In this embodiment, the elasticity of the material is higher initially when the material in the embedded pockets is still in a liquid or in a highly deformable form). After hardening or curing of the embedded substance, the sheet of material 10 has a higher rigidity and is less elastic. At a higher concentration of the embedded pockets, the material would have a higher rigidity after curing of the curable liquid 20. It must be noted that the structural elements are also at least partially encapsulated or embedded in the elastomeric layer.

In one example, the pockets 20 in FIG. 3 may contain a curable polymer based on epoxy groups. The elastomeric layer in this case may be a polymer that is flexible when only partially cured. The layer would be partially cured so as to be maneuverable, unlike a completely uncured liquid. An example would be a partially cross-lined polyurethane. Once formed into the desired shape, the material could then be completely cured and the epoxy polymer 20 would cross-link and the structure would become rigid.

As another alternative, the shape of the structural elements may be varied to increase the stretchability of the material in the uncured state. In the embodiment shown in FIG. 4, the structural elements have protrusions such as 22 that may contact the elastomeric layers 12 and 14. This allows for the material to have the desired rigidity when in cured form. The structural elements 18 are nearly surrounded by the curable liquid 20, which would also allow them to be more flexible in the uncured form.

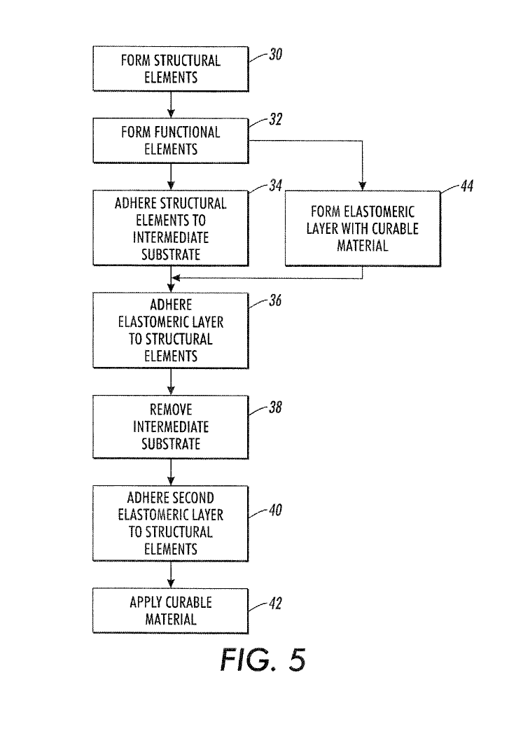

The manufacture of the material may be accomplished in several ways. One embodiment of a method of manufacturing the flexible material is shown in FIG. 5. The structural elements may be formed at 30. This process is optional, as the structural elements may be previously formed or purchased. Similarly, as the inclusion of function elements is a variation on the basic material, the process of forming the functional elements at 32.

In the embodiment using the two elastomeric layers, such as one similar to the one in FIG. 1, an intermediate substrate may be used such as 34. This allows the structural elements to be mounted to the intermediate substrate and placed. In one example, the intermediate substrate used was Gelpack or other slightly tacky silicone-based material. Other options include sacrificial layers, like soluble polymers, or UV releasable tape. After the structural elements were mounted to the intermediate substrate, the first elastomeric layer is applied to the surface of the structural components opposite the surface to which the intermediate substrate is attached.

At 38, the intermediate substrate can be turned over and then removed from the surface of the structural elements. A second layer may be adhered to the surface of the structural elements that was previously attached to the intermediate substrate at 40. Once the second elastomeric layer is attached, the curable material is applied at 42. The curable material may be introduced by capillary filling, or it may be introduced before application of the second elastomeric layer.

In an alternative embodiment, such as the one shown in FIG. 3, the elastomeric layer with curable material is formed at 44. The structural elements can then be attached to the elastomeric layer at 34. At this point, the process may end resulting in the structure such as the one shown in FIG. 3.

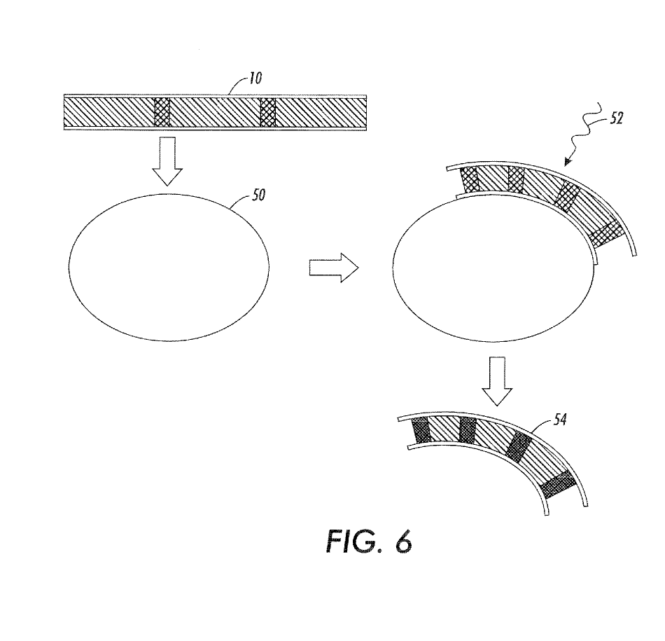

Once formed, the material or structure can be molded, shaped, bent, or otherwise formed into whatever shape desired. The material is then cured, such as by applying UV light. The curable material hardens and retains the desired shape. FIG. 6 shows an example of this process. The material 10 can be formed around a sphere 50. While the material is in the shaped form, it is exposed to UV light 52, in the case of a UV curable material. The resulting structure 54 has taken the form of a partial sphere. Several layers of the material may be stacked in order to achieve a greater thickness and higher mechanical stiffness of the cured material. For example, the material may be used as a structural reinforcement for some underlying structure. If the structural elements are made of a ceramic or steel for example, the material could give the underlying structure almost the strength of a ceramic or a steel structure. In one example the material would make the underlying structure more resistant to external impact forces, in another example, when a conducting structural or functional element is used, the material may become a shield for electromagnetic radiation.

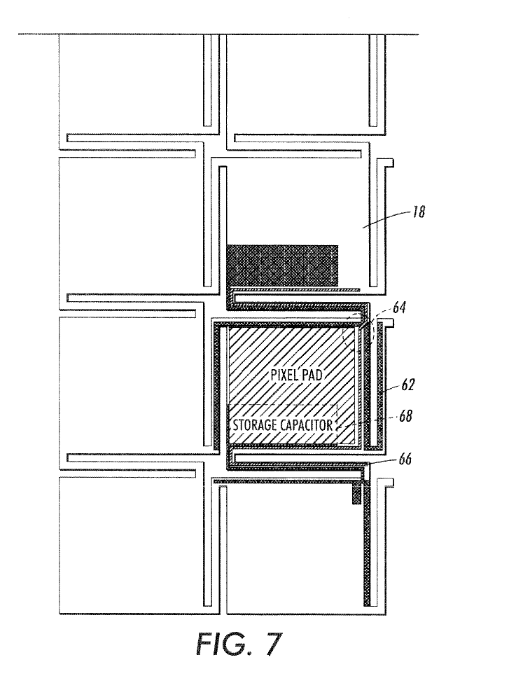

One possible implementation of a spherical surface is a wide-field-of-view image sensor or a spherical display. FIG. 7 shows an example of such a structure in top view in the flat state. In the embodiment, each of the structural components 18 is connected to the other structural components by flexure beams. Flexure beams may be applied to any embodiment of the structural components discussed here, not just to the application of a display or image sensor. The flexure beams may give the materials more rigidity; they may provide a higher spring force when the material is stretched and they may help to retain the shape of the material after it is deformed. For example if the structural elements and the beams are made from steel foil, the steel foil may remain plastically deformed after bending the material.

Similarly, the flexure beams may support not only the connection between the structural components mechanically, but also allow formation of electrical connections by supporting connection lines on the flexure beams. This is shown in FIG. 7, with the data line 66 and the gate line 62 of a pixel structure. A thin-film transistor (TFT) may be formed such as at 64. Similarly, each of the functional components may include a storage capacitor 68 that allows each functional component to retain its state. The pixel structure shown in FIG. 7 is only an example to illustrate the purpose of the flexure beams. The flexure beams provide the electrical connection between the electronic elements and in the case of display pixels the gate and data lines are routed along the flexure beams. In the case of pixel structures, the pixel circuit may be combined with a display material such as electroluminescent or OLED material or an electrophoretic ink. For OLED displays the pixel structure would be more complex and additional address lines may have to be routed along the flexure beams. For an image sensor, the pixel circuit would also carry a photodiode made by depositing e.g. amorphous silicon pin-photodiode layers. Although only one pixel structure is shown in FIG. 7 on each structural element, it would be also possible to pattern multiple pixels on each structural element. In addition to this example, the flexural beams may also connect other electronic or optical structures, such as MEMS sensors (e.g. bolometers) or actuators (e.g. micromirrors) or optical light emitters which are connected through optical light guides patterned on the flexural beams, for example. Moreover, the structural elements may have photovoltaic cells patterned on them and the flexure beams, or conductive traces on the flexure beams, provide a serial or parallel connection of these cells. The elements may also have electroluminescent devices patterned on them and via the flexure beams again the electrical connection is provided.

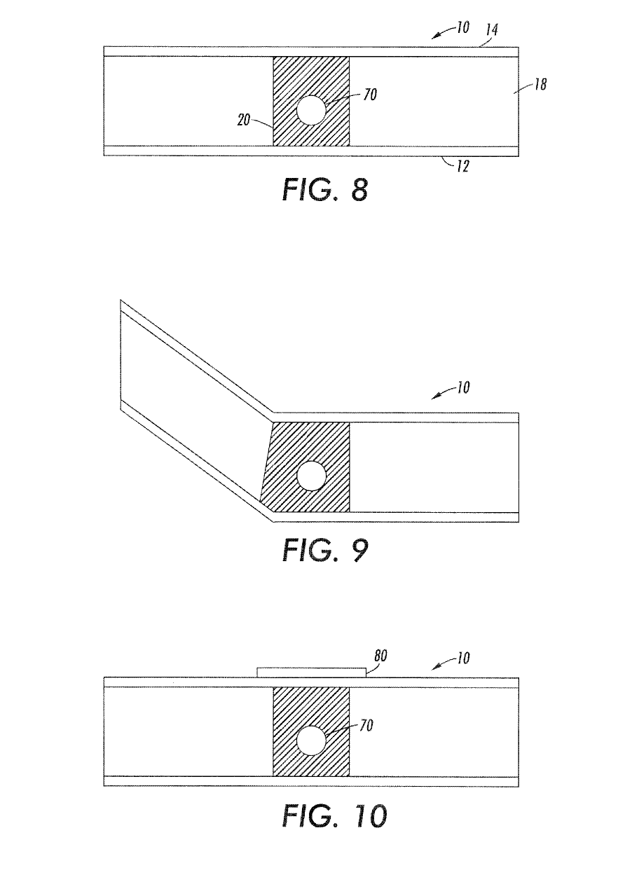

Up to this point in the discussion, the embodiments have assumed that the elastomeric layers allow the curing force, such as heat or light, to penetrate to the curable material. In some instances, the elastomeric layer may block the light or heat or the curable material may be in an inaccessible location or it may be surrounded by material that blocks radiation, heat or light. In such cases, the material 10 from FIGS. 1-4 may require internal curing. An example of such an internally curing material is shown in FIG. 8.

The material 10 has first and second elastomeric layers 12 and 14, structural components such as 18, and the curable material 20 in between the structural components. In addition, an internal curing structure 70 cures the curable material upon application of some sort of energy. For example, for UV-curable material, the internal curing structure may be an optical fiber or another kind of light guide. Externally, a light source such as a laser, an LED, a mercury or halogen lamp or other light source is then attached to send light through the light guide in order to cure the material. The light guide may have to have surface features that allow the light to couple out of the light guide. This may be in form of a roughened surface or in form of an adjusted refractive index of the surrounding material. Light may couple out of the light guide only in certain regions that require stiffening, which is achieved e.g. by texturing the light guide only in these certain regions to allow light to couple out. For heat-curable materials, the internal curing structure may be a heating element or wire which heats up when an electrical current is passed through. The electrical resistance of the heating elements may be adjusted to allow preferential or faster curing in certain regions and slower curing in others.

The internal curing structure may be applied to any of the architectures of the material discussed here. After deforming the material, it may be internally hardened or cured to retain the desired shape. An example of this is shown in FIG. 8 where the material has been bent and forms a hinge. In FIG. 9, the material 10 has been formed with a bend and then internally hardened at the bend.

In yet another variation, the formation of the bend may be performed by an actuator of some sort, such as a shape-memory polymer. FIG. 10 shows the addition of the actuator 80 to the material. In this embodiment, the actuator 80 would cause the material to deform into a structure having a bend and then the internal curing structure 70 would cause it to become rigid in that shape by hardening the curable material 20.

All of the variations discussed above can be used in various combinations of structures and material. The resulting material is an initially flexible material that can be formed into various shapes and then cured to become rigid in that shape. This material has many applications including engineering, construction and even sculpting.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A flexible structure, comprising:
at least one elastomeric layer;
at least two structural elements adjacent the elastomeric layer; and
a curable material arranged adjacent to the elastomeric layer and the structural elements.

2. The flexible structure of claim 1, wherein the elastomeric layer further comprises first and second elastomeric layers.

3. The flexible structure of claim 2, wherein the structural elements are arranged between the first and second elastomeric layers and the curable material is arranged between the structural components.

4. The flexible structure of claim 1, wherein the structural elements are in mechanical contact with at least a portion of the elastomeric layer.

5. The flexible structure of claim 1, wherein the elastomeric layer further comprises an elastic polymer embedded with the curable material.

6. The flexible structure of claim 1, wherein the elastomeric layer further comprises one of silicone, acrylic, urethane, or rubber.

7. The flexible structure of claim 1, wherein the structural elements further comprise one of polymethyl methacrylate, plastic, metal, glass, ceramic, silicon, gallium arsenide, plexiglass or sapphire.

8. The flexible structure of claim 1, wherein the curable material further comprises one of radiation-curable material, UV-light curable material, heat-curable material or oxygen-curable material.

9. The flexible structure of claim 1, wherein the structural elements are connected together by at least one flexure beam.

10. The flexible structure of claim 1, further comprising an optical light guide within the curable material.

11. The flexible structure of claim 1, further comprising a deforming actuator arranged adjacent the curable material.

12. The flexible structure of claim 1, further comprising a functional element.

13. The flexible structure of claim 12, wherein the functional element further comprises one of a pixel drive element, a sensor, a photovoltaic cell, a light emitting device or a microelectromechanical system (MEMS) structure.

14. A method of manufacturing a flexible structure comprising:
adhering an elastomeric layer to at least two structural components to form a flexible structure; and
applying a curable material to the flexible structure such that the curable material is arranged adjacent to the elastomeric layer and the structural components.

15. The method of claim 14, further comprising adhering a second elastomeric layer to the structural components on an opposite side from the elastomeric layer, wherein applying the curable material further comprises applying the curable material between the two elastomeric layers.

16. The method of claim 14, further comprising forming a functional component on a surface of at least one of the structural components.

17. The method of claim 14, further comprising forming at least one connection between the structural components.

18. The method of claim 14, wherein applying the curable material further comprises embedding capsules of curable material into the elastomeric layer.

19. An apparatus, comprising:
at least one elastomeric layer;
at least two structural components arranged adjacent to and in contact with the elastomeric layer;
a functional component arranged adjacent to and in contact with at least one of the structural components; and
a curable material arranged adjacent to the elastomeric layer and the structural components.

20. The apparatus of claim 19, the functional component further comprising a pixel drive element, a sensor, a photovoltaic cell, a light emitting device, or a microelectromechanical system (MEMS) structure.
